(19) United States
(12) Patent Application Publication
(10) Pub. No.: US 2026/0194454 A1
(43) Pub. Date: Jul. 9, 2026

(54) HIGH-THROUGHPUT ANALYSIS UNIT

(71) Applicant: AVICENA SYSTEMS LIMITED, West Perth, Western Australia (AU)

(72) Inventors: Anthony Malcolm Stevens, West Perth (AU); Paul Michael Watt, Mount Claremont (AU)

(21) Appl. No.: 19/123,977

(22) PCT Filed: Oct. 24, 2023
(86) PCT No.: PCT/AU2023/051061

§ 371 Date: Apr. 24, 2025

(30) Foreign Application Priority Data
Oct. 24, 2022 (AU) 2022903149

(51) Int. Cl. G01N 21/25; G01N 21/64; G01N 35/00; G01N 35/10

(52) U.S. Cl. CPC G01N 21/253; G01N 21/6452; G01N 35/00584; G01N 35/0099; G01N 35/1002; G01N 2035/00356

(57) ABSTRACT

The disclosure relates to a screening system configured to identify biological agents, biological differences, pathogens and/or genetic differences. The screening system may include an incubation zone having an incubation station for incubating a plurality of samples, and a detector for detecting electromagnetic radiation emitted by the plurality of samples, simultaneously or quasi-simultaneously. The screening system may include an optional replaceable incubator unit that is receivable in the incubation station. The incubation station may include a light-based datum system that is used as a reference point to orientate images of the incubation station captured by the detector and optionally to assist with the synchronisation of capture of spectral images corresponding to the output of the assays for pathogens or genetic differences.

### TECHNICAL FIELD

The present disclosure relates to a screening system to identify pathogens or genetic differences and relates particularly, though not exclusively, to a system for the detection of genetic differences, either in the DNA or RNA of genes, or in gene expression profiles.

### BACKGROUND

Especially the COVID-19 pandemic, but also other pandemics or epidemics require screening of large numbers of samples taken from symptomatic individuals who are expected to carry a virus or for routine surveillance screening of asymptomatic individuals in order to identify carriers of the virus. Different manual screening procedures are known, but in order to enable surveillance testing of larger numbers of samples, screening systems that enable higher throughput of samples are becoming more and more important.

Multiple sensitive and molecular diagnostic techniques exist for the detection of pathogens such as SARS-cov2 using a range of nucleic acid amplification and detection system, including the polymerase chain reaction (PCR), Isothermal Amplification methods and CRISPR based methods-for review reference is being made to [Habli, Z., Saleh, S., Zaraket, H. & Khraiche, M. L. COVID-19 in-vitro Diagnostics: State-of-the-Art and Challenges for Rapid, Scalable, and High-Accuracy Screening. Frontiers in Bioengineering and Biotechnology 8, (2021)].

Those skilled in the art will be aware that the disclosure could be applied to a range of newer molecular tests with optical readouts for both nucleic acid and protein targets, which are emerging which include, but are not limited to, technologies disclosed in the following publications:

Zhang, X., Zhao, Y., Zeng, Y. & Zhang, C. Evolution of the Probe-Based Loop-Mediated Isothermal Amplification (LAMP) Assays in Pathogen Detection. Diagnostics 13, 1530 (2023).

Loop Mediated Isothermal Amplification (LAMP)—comprehensively reviewed here: [Moehling, T. J., Choi, G., Dugan, L. C., Salit, M. & Meagher, R. J. LAMP Diagnostics at the Point-of-Care: Emerging Trends and Perspectives for the Developer Community. Expert Rev Mol Diagn 21, 1-19 (2021)].

MD-LAMP [Becherer, L. et al. Simplified Real-Time Multiplex Detection of Loop-Mediated Isothermal Amplification Using Novel Mediator Displacement Probes with Universal Reporters. Anal Chem 90, 4741-4748 (2018)].

### CRISPR

Liu, F. X., Cui, J. Q., Wu, Z. & Yao, S. Recent progress in nucleic acid detection with CRISPR. Lab Chip 23, 1467-1492 (2023).

Pena, J. M. et al. Real-time, multiplexed SHERLOCK for in vitro diagnostics. J. Mol. Diagn. 25, 428-437 (2023).

Nguyen, L. T. et al. Engineering highly thermostable Cas12b via de novo structural analyses for one-pot detection of nucleic acids. Cell Rep. Med. 4, 101037 (2023).

DETECTR [Broughton, J. P. et al. CRISPR—Cas12-based detection of SARS-COV-2. Nat Biotechnol 38, 870-874 (2020)].

miSHERLOCK [Puig, H. de et al. Minimally instrumented SHERLOCK (miSHERLOCK) for CRISPR-based point-of-care diagnosis of SARS-COV-2 and emerging variants. Sci Adv 7, eabh2944 (2021)]

### Autocatalytic CRISPR

CONAN. [Shi, K. et al. A CRISPR-Cas autocatalysis-driven feedback amplification network for supersensitive DNA diagnostics. Sci. Adv. 7, eabc7802]

Deng, F., Sang, R., Li, Y., Deng, W. & Goldys, E. Bifunctional circular DNA amplifier transforms a classic CRISPR/Cas sensor into an ultrasensitive autocatalytic sensor. (2023) doi: 10.21203/rs.3.rs-2626952/v1.

Deng, F., Li, Y., Hall, T., Vesey, G. & Goldys, E. M. Bi-functional antibody-CRISPR/Cas12a ribonucleoprotein conjugate for improved immunoassay performance. Anal Chim Acta 1259, 341211 (2023).

SPOT. [Xun, G., Lane, S. T., Petrov, V. A., Pepa, B. E. & Zhao, H. A rapid, accurate, scalable, and portable testing system for COVID-19 diagnosis. Nat Commun 12, 2905 (2021)].

RTF-EXPAR [Carter, J. G. et al. Ultrarapid detection of SARS-COV-2 RNA using a reverse transcription-free exponential amplification reaction, RTF-EXPAR. Proc National Acad Sci 118, (2021)].

NACT [Moitra, P., Alafeef, M., Dighe, K., Frieman, M. B. & Pan, D. Selective Naked-Eye Detection of SARS-COV-2 Mediated by N Gene Targeted Antisense Oligonucleotide Capped Plasmonic Nanoparticles. Acs Nano 14, 7617-7627 (2020); Alafeef, M., Moitra, P., Dighe, K. & Pan, D. RNA-extraction-free nano-amplified colorimetric test for point-of-care clinical diagnosis of COVID-19.Nat Protoc 16, 3141-3162 (2021)].

Isothermal PCR. [Gavrilov, M. et al. Engineered helicase replaces thermocycler in DNA amplification while retaining desired PCR characteristics. Nat Commun 13, 6312 (2022).].

Those skilled in the art will appreciate that the above list of nucleic acid amplification (NAAT) technogies is not exhaustive and does not explicitly mention other applicable technologies, including RPA, RCA, SPA, NASBA, see: [Wang, M. et al. Enzyme-Assisted Nucleic Acid Amplification in Molecular Diagnosis: A Review. Biosensors 13, 160 (2023)].

Those skilled in the art will be aware that the products of the above molecular diagnostic assays (whether based on nucleic acid amplification assays, CRISPR or protein or nanoparticle based biosensors) can be detected through changes in colour (detected by differences in absorbance reflectance or transmission of illuminated light), luminescence phosphorescence or fluorescence. For example, the following reviews describe a range of nucleic acid aptamer, protein and nanoparticle biosensors with optical outputs: [Singh, A. K., Mittal, S., Das, M., Saharia, A. & Tiwari, M. Optical biosensors: a decade in review. Alex. Eng. J. 67, 673-691 (2023).

Xu, R., Ouyang, L., Chen, H., Zhang, G. & Zhe, J. Recent Advances in Biomolecular Detection Based on Aptamers and Nanoparticles. Biosensors 13, 474 (2023).

Futane, A., Narayanamurthy, V., Jadhav, P. & Srinivasan, A. Aptamer-based rapid diagnosis for point-of-care application. Microfluid. Nanofluidics 27, 15 (2023)].

Those skilled in the art will appreciate the application of this disclosure to a range of homogeneous isothermal assays for nucleic acid, protein, or small molecule based targets—see: [Dekaliuk, M., Busson, P. & Hildebrandt, N. Isothermal Rolling Circle Amplification and Lanthanide-Based FRET for Femtomolar Quantification of MicroRNA. Anal. Sens. 2, (2022)] and [Fu, H.-J. et al. Rapid and Wash-Free Time-Gated FRET Histamine Assays Using Antibodies and Aptamers. ACS Sens. 7, 1113-1121 (2022). Li, Y., Liu, L., Qiao, L. & Deng, F. Universal CRISPR/Cas12a-associated aptasensor suitable for rapid detection of small proteins with a plate reader. Front. Bioeng. Biotechnol. 11, 1201175 (2023)], and [Kadam, U.S., Cho, Y., Park, T. Y. & Hong, J. C. Aptamer-based CRISPR-Cas powered diagnostics of diverse biomarkers and small molecule targets. Appl Biol Chem 66, 13 (2023)], respectively for examples of applicable assays.

One promising technique used for screening molecular signatures in samples is the so-called “Loop Mediated Isothermal Amplification (“LAMP”) technique. The screening process involves collecting biological samples (such as, but not limited to saliva, sputum, anterior nasal, mid-turbinate, or nasopharyngeal swabs and throat swabs), and placing the samples into test tubes, together with chemicals used for the LAMP process. The samples are then incubated and colorimetric or fluorometric detection techniques may be used to determine an outcome of the screening process. LAMP has the advantage that the incubation and the detection process can take as little as 20 to 30 minutes. Screening systems may be used for parallel processing and screening of samples thereby increasing the throughput compared with manual LAMP procedures.

However, to date the molecular diagnostics methods disclosed above, are currently implemented in low-throughput point-of-care formats, or in medium formats, without a feasible and economic means to operate at an ultra high-throughput scale. This means the standard approaches to molecular diagnostics disclosed above are not applicable to ultra high-throughput screening methods, particularly those methods supporting continuous operation at several thousand tests per hour. For example, even costly, high throughput molecular diagnostics instruments such as the Roche Cobas 6800, the Abbott Alinity, the Quiagen QIAstat-Dx, NeuMoDx or the Hologic Panther instruments, some of which support more continuous flow loading modes are not configured in a manner which allows economical scaling to continuous ultra-high throughput operation due to inherent design constraints.

Point of care solutions linked to small molecular assay devices and/or to smart phones also have their own limitations in ID verifiability, integration and affordable costs for implementation at the population scale or in biosecurity surveillance applications.

Accordingly, the ability to rapidly screen very large number of samples associated with a pandemic or to screen economically for genetic or phenotypic changes at the population level in minimum timeframes, requires not only parallel processing of the samples at ultra-high throughput, but also requires further technical solutions for increasing throughput and versatility, allowing flexible adaptation for fluctuations in testing volumes such as, but not limited to scalable random access, continuous flow loading. There is a need for technological advancement.

It is to be understood that, if any prior art publication is referred to herein, such reference does not constitute an admission that the publication forms a part of the common general knowledge in the art, in Australia or any other country.

### SUMMARY

Embodiments are directed to a screening system configured to identify biological agents, biological differences, pathogens and/or genetic differences with a continuous screening throughput rate of at least 2000 samples per hour. Such a system may be referred to a continuous “ultra high-throughput” screening system.

An embodiment provides a screening system to identify pathogens or genetic differences, the screening system comprising:
an incubation zone having an incubation station for incubating a plurality of samples;
a source of electromagnetic radiation for illuminating the plurality of samples;
a detector for detecting electromagnetic radiation emitted by the plurality of samples;
a reference system for measuring a position of the detector relative the incubation station.

The reference system may include a light-based datum system. The reference system may include an optical, acoustic and/or magnetic detector that is configured to measure a distance. The distance may be used to calculate relative positions of the detector and incubation station. The optical, acoustic and/or detector may include an ultrasonic detector and/or laser light. The magnetic detector may include a detector that can detect a change in a magnetic condition. For example, a change in a magnetic condition may occur at a location of the incubation station. The magnetic detector may also include linear encoders that use a magnetic coding over a length of travel.

An embodiment provides a screening system to identify pathogens or genetic differences, the screening system comprising:
an incubation zone having an incubation station for incubating a plurality of samples;
an incubator unit that is receivable in the incubation station, the incubator unit being replaceable and comprising:
   a heating element or thermal regulator having a plurality of receptacles that can each receive a sample, the heating element or thermal regulator being configured to heat or cool the plurality of receptacles; and
   a source of electromagnetic radiation for illuminating one or more of the receptacles; and
a detector for detecting electromagnetic radiation emitted by the plurality of samples.

In an embodiment, the screening system may comprise a plurality of incubation stations that can each receive an incubator unit. Each incubator unit may be operable independent of one another. This may help the system to concurrently analyse samples that require different incubation conditions. The thermal regulator may be positioned in or form an in-use upper portion of the incubator unit. The source of electromagnetic radiation may be positioned in or form an in-use lower portion of the incubator unit. In an embodiment, each receptacle is optically connected to the source of electromagnetic radiation via a fibre optic cable. However, the disclosure is not limited to the use of fibre optic cables and alternative embodiments may be used to allow the source of electromagnetic radiation to pass into the receptacle.

The incubator unit may include an identifier that can be read by the incubation station upon installation of the incubator unit into the incubation station. The identifier may be used to identify predefined operational conditions of the incubator unit.

The incubator unit may include a light-based datum system that can generate light that is used as a reference point to orientate images of the incubation station captured by the detector. The light-based datum system may include a laser light source and a photodetector. The laser light may be detected by the photodetector to generate a signal to capture an image of the plurality of samples.

An embodiment provides a screening system configured to identify biological agents, biological differences, pathogens and/or genetic differences, the screening system comprising:
an incubation zone having an incubation station for incubating a plurality of samples, the incubation station having a light-based datum system;
a source of electromagnetic radiation for illuminating the plurality of samples;
a detector for detecting electromagnetic radiation emitted by the plurality of samples; and
wherein the light-based datum system is used as a reference point to orientate images of the incubation station captured by the detector.

The light-based datum system may be considered as forming a location system to help provide a location of the incubation station. Light emitted from the light-based datum system may be detected by the detector. The screening system may comprise a plurality of incubation stations. The incubation station may include an incubator unit having a heating element or thermal regulator, such as a magnetic induction or piezoelectric system, for heating or cooling the plurality of samples. The incubator system may be replaceable. The light-based datum system may be located on the thermal regulator. The incubator unit may include the source of electromagnetic radiation for illuminating the plurality of samples.

In an embodiment, the source of electromagnetic radiation is configured to illuminate the plurality of samples in a first wavelength range and the detector is configured to detect electromagnetic radiation emitted by the plurality of samples in a second wavelength range. The second wavelength range may be different to the first wavelength range. The light-based datum system may be visible in the second wavelength range.

The light-based datum system may include two light-based datums located at the incubation station. The light-based datum system may include a laser source that triggers a photodetector located at the incubation station. Triggering the photodetector may provide a signal to the detector to capture the electromagnetic radiation emitted by the plurality of samples. The trigger may help to ensure the detector is in the same position for each image capture.

The system may be configured such that electromagnetic radiation emitted by the plurality of samples and the light from the light-based datum system may be detected simultaneously. The system may be configured such that the electromagnetic radiation emitted by the plurality of samples can be detected simultaneously, for example by means of a multispectral detector and/or via a split-beam or prism linked to multiple detectors. The system may be configured such that the electromagnetic radiation emitted by the plurality of samples can be detected at least quasi-simultaneously, such as by means of a filter wheel multiple and/or narrow-band filter-based imager/camera, using synchronised detection of the light emitted from the light-based datum location system.

The light-based datum system may include a light source located at the incubation station. In an embodiment of a screening system, the detector and incubation station may be moveable relative to one another. An embodiment of a screening system may further comprise a movement mechanism configured tor move the detector across the incubation zone. The screening system may be configured such that the detector continually moves across the incubation zone in use of the system. The detector may continually move back and forth across the incubation zone. In an embodiment, the system may be configured such that the at least quasi-simultaneous detection of the electromagnetic radiation emitted by the plurality of samples includes detecting light from the light-based datum system either at a predefined interval immediately before or immediately afterward detection of the electromagnetic radiation emitted by the plurality of samples followed by time resolution to allow calculation of location of the plurality of samples from the light-based datum system by interpolation of the trajectory of relative motion of the detector and the incubation zone.

In an embodiment of a screening system, the detector is a fixed detector and has a field of view that captures at least one incubation station. An embodiment of a screening system may include a plurality of detectors. An embodiment of a screening system may comprise a plurality of incubation stations. Each detector of the plurality of fixed detectors may be configured to record radiation emitted from some of the plurality of incubation stations such that the plurality of fixed detectors in combination record radiation emitted the plurality of incubation stations. Each detector of the plurality of detectors may be configured to record radiation emitted by the plurality of samples at a predefined wavelength or at one or more predefined wavelengths that is different to the other of the detectors of the plurality of detectors. In an embodiment, at least one of the plurality of detectors is configured to record radiation emitted by the plurality of samples at a predefined wavelength that is distinct from at least one of the detectors of the plurality of detectors, wherein at least one detector of the plurality of detectors is configured to record radiation at the same as the other but distinguished by means of time resolved detection of asynchronous radiation in response to an excitation pulse provided from the source to electromagnetic radiation.

An embodiment provides a screening system to identify pathogens or genetic differences, the screening system comprising:
an incubation zone having an incubation station for incubating a plurality of samples,
an incubator unit that is receivable in the incubation station, the incubator unit being replaceable and comprising:
   a thermal regulator having a plurality of receptacles for receiving a sample, the thermal regulator configured to heat or cool the plurality of receptacles;
   a source of electromagnetic radiation that is optically connected to the receptacles for illuminating the plurality of samples; and
   a light-based datum system; and
a detector for detecting electromagnetic radiation emitted by the plurality of samples and light from the light-based datum system;
wherein the light-based datum system is used as a reference point to orientate images of the incubation station captured by the detector.

An embodiment of a screening system may further comprise a liquid handling system for transferring liquid reagents to the plurality of samples. The liquid handling system may include a pipette for transferring liquid and that in use can receive and dispense pipette tips from a pipette tip rack. An embodiment may further comprise a detector for visually detecting the presence or absence of one or more pipette tips in the pipette tip rack.

An embodiment of a screening system may further comprise an airflow system. The airflow system may have an inlet positioned to suck air in from an environment outside of the screening system, a filter, and an outlet located in a chamber that houses the liquid handling system. The airflow system may be configured to suck air in through the inlet and filter to form purified air and then blow the purified air into the chamber that houses the liquid handling system. The airflow system may be configured to maintain the chamber that houses the liquid handling system at an elevated pressure compared to an environment outside of the chamber that houses the liquid handling system. The airflow system may include a duct for directing purified air to an upper portion of the chamber that houses the liquid handling system.

An embodiment of a screening system may further comprise a robotic system for loading and unloading of samples. The system for screening of pathogens or genetic differences may be arranged to identify if and when the screening and/or processing is completed for individual samples or groups of samples in the incubation zone. In an embodiment, the robotic system may be arranged to remove the individual samples or groups of samples from the incubator leaving vacant sample holders or groups of sample holders. Samples or groups of samples may be removed from locations surrounded by, or adjacent to, samples or groups of samples for which screening and/or processing is not completed. The robotic system may be arranged to obtain fresh samples or groups of samples; and thereafter fill the vacant positions in the incubator with the fresh samples. The system may be suitable for continuous throughput of samples. For example, an embodiment of the screening system may be configured for continuous operation where incubated samples are continually removed and replaced with new samples.

An embodiment of a screening system may include an ultrasonic detector for detecting one or more physical conditions of the system. The one or more physical conditions of the system may include the presence or absence of a sample in a predefined location in the incubation zone. For example, the sample may be a microplate having a plurality of samples. An embodiment may further comprise a bin or waste receptacle configured to receive waste generated by the screening system. The ultrasonic detectors may be configured to measure a fill level of the bin or waste receptacle.

An embodiment provides a screening system configured to identify biological agents, biological differences, pathogens and/or genetic differences, the screening system comprising:
an incubation zone having an incubation station for incubating a plurality of samples, wherein an incubator unit that is receivable in the incubation station and replaceable, the incubator unit comprising:
   a thermal regulator having a plurality of receptacles that can each receive a sample, the thermal regulator being configured to heat or cool the plurality of receptacles; and
a source of electromagnetic radiation for illuminating one or more of the receptacles;
a source of electromagnetic radiation for illuminating the plurality of samples;
a detector for detecting electromagnetic radiation emitted by the plurality of samples;
a chamber that houses a liquid handling system for transferring liquid reagents to the plurality of samples; and
an airflow system having an inlet positioned to suck air in from an environment outside of the screening system, a filter, and an outlet located in the chamber, the airflow system being configured:
   to suck air in through the inlet and filter to form purified air and then blow the purified air into the chamber; and
   maintain the chamber at an elevated pressure compared to an environment outside of the chamber.

The incubation station may have a light-based datum system. The light-based datum system may be used as a reference point to orientate images of the incubation station captured by the detector. The detector may be in a fixed relationship relative to the incubation zone. The detector may be moveable relative to the incubation zone.

An embodiment provides a screening system configured to identify biological agents, biological differences, pathogens and/or genetic differences, comprising:
an incubation zone having an incubation station for incubating a plurality of samples;
a source of electromagnetic radiation for illuminating the plurality of samples;
a detector for detecting electromagnetic radiation emitted by the plurality of samples;
a chamber that houses a liquid handling system for transferring liquid reagents to the plurality of samples; and
an airflow system having an inlet positioned to suck air in from an environment outside of the screening system, a filter, and an outlet located in the chamber, the airflow system being configured: to suck air in through the inlet and filter to form purified air and then blow the purified air into the chamber; and maintain the chamber at an elevated pressure compared to an environment outside of the chamber.

The incubation station may include a light-based datum system. The light-based datum system may be used as a reference point to orientate images of the incubation station captured by the detector. The screening system may further comprise an incubator unit that is receivable in the incubation station and replaceable. The incubator unit may comprise: a thermal regulator having a plurality of receptacles that can each receive a sample, the thermal regulator being configured to heat or cool the plurality of receptacles; and a source of electromagnetic radiation for illuminating one or more of the receptacles.

An embodiment provides a screening system configured to identify biological agents, biological differences, pathogens and/or genetic differences, comprising:
an incubation zone having an incubation station for incubating a plurality of samples;
a source of electromagnetic radiation for illuminating the plurality of samples; and
a detector for detecting electromagnetic radiation emitted by the plurality of samples;
wherein the incubation station and the detector are either moveable relative one another or in a fixed relationship.

One or more embodiments of a screening system may be configured for continuous identification of biological agents, biological differences, pathogens and/or genetic differences.

### BRIEF DESCRIPTION OF THE DRAWINGS

Embodiments will now be described, by way of example only, with reference to the accompanying non-limiting drawings, in which:

FIG. 1 is a perspective view of an embodiment of a screening system.

FIG. 2 is a close-up perspective view of region A in FIG. 1.

FIG. 3 is a schematic view of an image captured by a detector at a first time point during incubation.

FIG. 4 is a schematic view of an image captured by a detector at a second time point during incubation.

FIG. 5 is an embodiment of a light-based datum system.

FIG. 6 is an embodiment of a light-based datum system.

FIG. 7 is an embodiment of a light-based datum system.

FIG. 8 is a top perspective view of an embodiment of an incubator unit.

FIG. 9 is a bottom perspective view of an embodiment of an incubator unit.

FIG. 10 is a perspective view of an embodiment of a screening system.

FIG. 11 is a cross-sectional view along line B-B in FIG. 10.

FIG. 12 is an end view of an embodiment of a screening system.

FIG. 13 is an end view of another embodiment of a screening system.

### DETAILED DESCRIPTION

Embodiments are directed to a screening system configured to identify biological agents, biological differences, pathogens and/or genetic differences. The screening system may have a continuous screening throughput rate of at least 2000 samples per hour. Such a system may be referred to a continuous “ultra high-throughput” screening system. Biological agents may include molecules that are used, formed and/or metabolised in biological systems including small molecules such as drugs, hormones and steroids, macromolecules such as biopolymers including proteins and carbohydrates, biological substrates and metabolites. Biological differences may include analysing one or more markers of a biological system to assess or determine changes in the biological system.

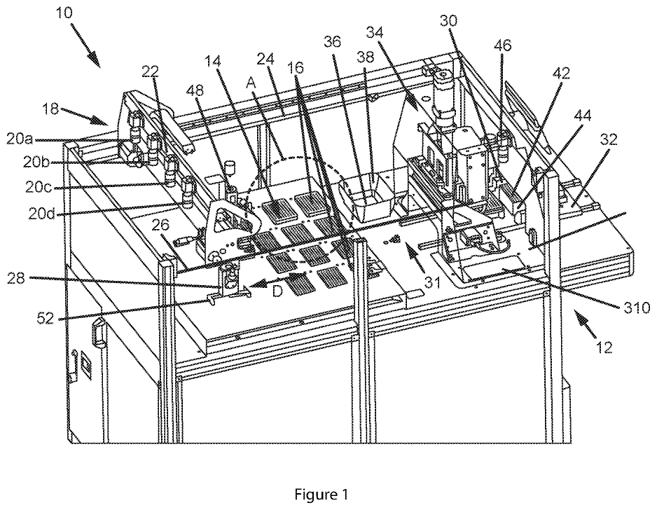

Starting at FIG. 1, screening system 10 has a structure 12 that supports an incubation zone 14. The incubation zone 14 has a plurality of incubation stations 16 that are each used to incubate a plurality of samples. Only an upper portion of the screening system 10 is shown in the Figures and features such as feet are omitted for clarity purposes only, which would be readily understood by the skilled person.

In the embodiment shown in FIG. 1 there are 12 incubation stations made up of three rows of four incubation stations 16 spread across a width of the incubation zone 14. Although twelve incubation stations 16 are shown in FIG. 1, there can be any number of incubation stations. For example, the incubation zone 14 could have one incubation station 16 or could have two or more incubation stations 16. In an embodiment, there are nX number of incubation stations 16, where n is the number of rows of incubation stations 16 in the incubation zone 14, and X is the number of incubation stations 16 in each row.

In use the incubation stations 16 receive samples that are then incubated over a predefined time-period to elicit change in fluorometric and/or optical properties of the sample depending on the properties of the pathogens or genetic differences of analytes in the sample. Each sample will typically have a fluorometric and/or colorimetric agent that will either alter the properties of fluorescent and/or transmissive electromagnetic radiation. In an embodiment, each incubation station 16 can receive a well insert, such as a 96-well insert.

The screening system 10 has a source of electromagnetic radiation in the form of a light for illuminating the plurality of samples (not shown in FIG. 1). The source of electromagnetic radiation can include one or more of an UV, visible, IR, near-IR and/far-IR light source. The source of electromagnetic radiation is associated with the incubation zone 14 in FIG. 1, but its actual location can vary depending on the illumination and/or excitation parameters required to analyse the analyte in each sample, and the type of incubation station 16.

The screening system 10 has a detector 18 for detecting electromagnetic radiation emitted by or passed through the plurality of samples. For example, if a fluorometric agent is used in the samples, the detector can detect an emission of the fluorometric agent following excitation from the source of electromagnetic radiation.

The detector 18 and the incubation station 16 may be moveable relative one another. For example, in an embodiment, the detector 18 is fitted to a gantry 22. The gantry 22 is connected to rails 24 and 26 such that the gantry 22 can move back and forth over the at least the incubation zone 14 along a length of the structure 12 in direction D. In an embodiment, the gantry 22 is connected to the rails 24 and 26 by linear bearings. In an embodiment, the gantry 22 is provided with wheels that run along rails 24 and 26. In an embodiment, the detector 18 can move along the gantry 22 between the rails 24 and 26.

In an embodiment, the detector 18 is in a fixed relationship relative to the incubation station 16 and/or incubation zone 14 (not shown). For example, the gantry 22 may be fixed to the rails 24 and 26. In such an embodiment, the fixed detector 18 has a field of view that captures at least one incubation station 16. If the fixed detector 18 can only capture some of the incubation stations 16, a plurality of fixed detectors 18 may be used such that each fixed detector 18 is configured to record radiation emitted from some of the plurality of incubation station 16 such that the plurality of fixed detectors 18 in combination image the plurality of incubation stations. For example, the screening system 10 may include two fixed detectors, where a first detector can detect electromagnetic radiation from a first half of the incubation zone 14 and a second camera can detect electromagnetic radiation from a second half of the incubation zone 14. The data, such as images, collected by the first and second detectors can be combined such that the first and second detectors can record radiation emitted from all incubation stations 16 in the incubation zone. The use of two detectors 18 is an example only and the screening system may use any number of fixed detectors 18. When the detector 18 is fixed relative the incubation station 16 and/or incubation zone 14, the detector 18 may be provide with an optical system to reduce optical issues such as parallax towards an edge of field of view of the detector 18.

In the embodiment shown in FIG. 1, the detector 18 includes a plurality of detectors. In an embodiment, the plurality of detectors includes cameras 20a-20d. In an embodiment, the number of cameras 20 is equal to the number of incubation stations 16 in each row of incubation stations 16 in the incubation zone 14. In this way, each camera 20a, 20b, 20c and 20d is responsible for detection along a ‘detection channel’ extending along a direction of the structure 12 i.e. direction D. When the detector 18 includes one or more cameras, the detection may be in the form of an image that is processed by a processing unit to analyse colorimetric and/or fluorometric properties of the samples captured in the image. However, a single camera may image two or more rows. For example, a first camera may image a first and second row, and a second camera may image a third and fourth row.

In an embodiment, the camera 20 may be one or more colour and/or IR cameras. The one or more cameras may be a single colour or multi-colour camera. The camera 20 may be a multispectral camera. The camera 20 may be a mechanical multispectral camera. The cameras and fluorometric agents used in the screening system may be that as outlined in PCT/AU2022/051036.

The screening system 10 may use multiple cameras where each camera detects light (i.e. electromagnetic radiation) at a wavelength or one or more a specific wavelengths. For example, a first detector may detect at a wavelength of 400 nm to 500 nm and a second detector may detector at a wavelength of 500 nm to 600 nm. In an embodiment, a control that is included in each sample of the plurality of samples may emit at a wavelength that is removed or orthogonal to other wavelengths or channels used to detect the biological agents, biological differences, pathogens and/or genetic differences in the plurality of samples. For example, the control may be triggered by the source of electromagnetic radiation at a beginning or end of an incubation period, where the emission from the control is within a wavelength range that is considered noisy or undesirable for probes and the like used to detect the differences in biological agents, biological differences, pathogens and/or genetic differences. In such an example, the source of electromagnetic radiation used to activate or excite the control may be activated at the beginning or end of incubation while at the same time electromagnetic radiation used to activate or excite the probes used to detect the differences in biological agents, biological differences, pathogens and/or genetic differences is deactivated or suppressed. Such an arrangement may eliminate the need to use a dedicated channel to monitor a control that would otherwise be needed to detect electromagnetic radiation emitted from the probes.

A robotic system 28 is used to load and unload samples into the incubation zone 14. The structure 12 typically includes sidewalls and a hood to prevent unwanted light and foreign matter interfering with the samples. The front sidewall and hood are omitted from FIG. 1 to better visualise the components of the screening system 10. Samples pass into the structure 12 through window 30 via actuator 32, where the robotic system 28 can move the samples from a pick-up zone 31 to a free incubation station 16. The actuator 32 may include a slidable plate that receives a plurality of samples such as a microplate and pipette tips.

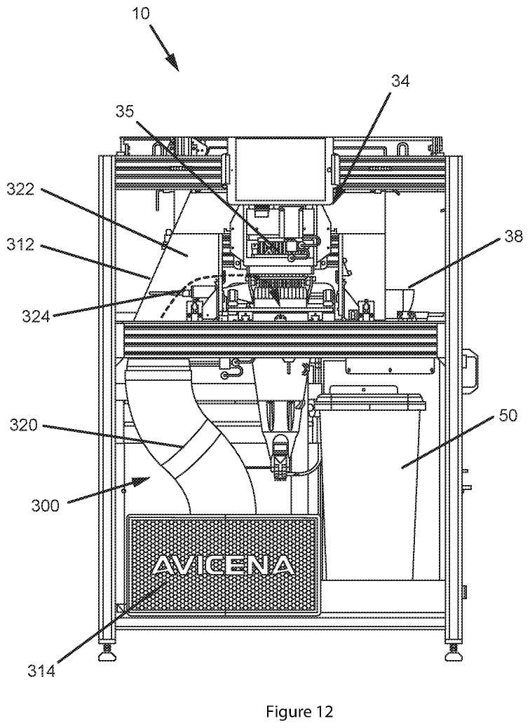

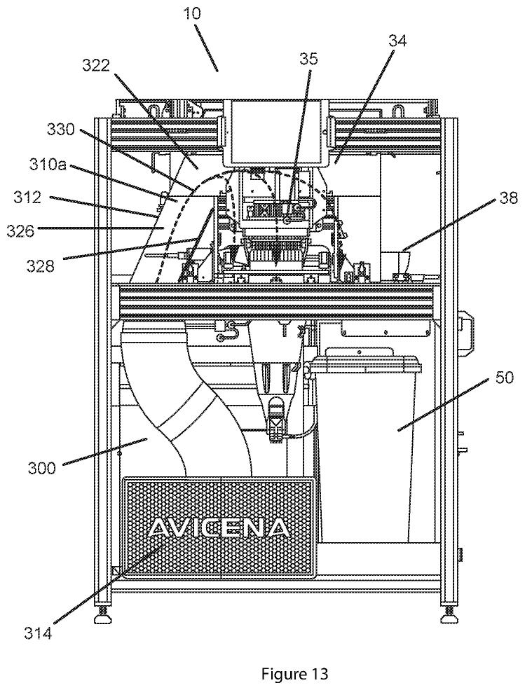

The screening system 10 includes a liquid handling system. The liquid handling system is shown in FIG. 1 as pipetting system 34 that is used to pipette reagents such as a fluorometric agent into the samples. The pipetting system 34 includes a pipette 35 (see FIG. 12 or FIG. 13), and pipette tips 42 that are located in a pipette tip rack 44. The pipette tip rack 44 may be provided as a cassette of pipette tips 42, or the pipette tips 42 can be provided on the actuator 32 and moved through the window with the sample. In use, the pipette 35 can receive and dispense pipette tips 42 from the pipette tip rack 44.

In use, samples pass through window 30, are then subject to pipetting system 34 to add reagents for incubation, and are then transferred to pick-up zone 31 where the robotic system 28 picks up and then moves the samples to a vacant incubation station 16 where they are subject to incubation. Following incubation, the samples are removed from the incubation station 16 and discarded thereby leaving a new vacant incubation station that can be filled with fresh samples. This process of feeding in new samples, incubation, and discarding incubated samples can occur continuously with a random access to the next available incubation station 16.

In an embodiment, the screening system 10 is provided with a waste chute 36 through which waste samples such as used microplates generated by the screening system 10 can be placed following incubation. A bin 50 is positioned under the waste chute that can collect discarded samples (see FIG. 12). The waste chute 36 can be fitted with a shroud 38 to direct discarded samples such as microplates into the waste chute. In the embodiment shown in FIG. 1, the waste chute 36 is positioned adjacent to the pick-up zone 31. Typically, once a sample has been discarded, a free incubation station 16 is made available for new samples that can be picked up in pick-up zone 31.

In an embodiment, the pipetting system 34 is provided with a detector in the form of camera 46 for visually detecting the presence or absence of one or more pipette tips 42 in the pipette tip rack 44. For example, during pipette pickup, the camera 46 can detect any missing or absent pipette tips 42 in the pipette tip rack 44 prior to the pipette tips 42 being placed on the pipette and/or detect any remaining or non-picked pipette tips 42 that may remain in the pipette tip rack 44 following pickup. The absence of a pipette tip 42 before pickup and the presence of a pipette tip 42 after pickup results in one or more samples not being correctly prepared thereby resulting in false-positive or false-negative results. Using the camera 46 to detect the absence or presence of pipette tips 42 during liquid sample transfer may trigger a system controller to alert a user of the error. Such an error can be corrected, if required, prior to incubation.

The screening system 10 is arranged to identify if and when the screening and/or processing is completed for individual samples or groups of samples in the incubation zone 14. For example, once samples in one incubation station 16 have completed incubation, the robotic system 28 can remove the samples from the incubation station 16 to provide a vacant incubation station 16 that can then be filled with new samples. This allows the screening system 10 to function for continuous throughput of samples. Each incubation station 16 can incubate samples independently from one another, eliminating the requirement for batch processing.

In use, the detector 18 continually scans the incubation stations 16 in the incubation zone 14 to monitor incubation of the plurality of samples. When the detector 18 includes a camera 20, the camera captures several images of an incubation station 16 over a defined incubation time-period. Because the camera moves along the length of the structure 12 via gantry 22 in direction D, the specific location of the camera relative the incubation station 16 when an image is captured can vary. To ensure the images captured by the camera are correctly processed, they should advantageously be aligned so that the location of each sample is consistent. Alignment can be achieved by using a reference locator or datum. However, for samples that are analysed with fluorometric methods, during the initial stages of incubation the incubation zone 14 is typically dark and devoid of any light source that could be used to illuminate the incubation stations 16. Using a light source to illuminate the incubation stations 16 would result in decreased sensitivity as any fluorometric response in the samples would be drowned out by the light source used to illuminate the incubation stations 16 for referencing.

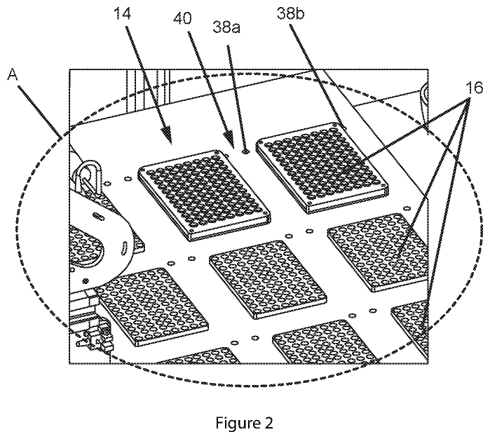

Accordingly, in an embodiment, the screening system 10 includes a datum in the form of light-based datum system 40 that is positioned in the incubation zone 14. The light-based datum system 40 uses a light source, such as a LED light, to provide a reference to align images along an X-Y axis. In an embodiment, the light-based datum system 40 uses two separate point light sources 38a and 38b that are associated with each incubation station 16, as shown in FIG. 2. The point light sources 38a and 38b remain in a fixed position relative the incubation station 16. In an embodiment, the detector 18 is configured to detect light emitted from the light-based datum system 40. For example, camera 20 can be used to detect the light from the light-based datum system 40. The light-based datum system 40 may remain fixed to the incubation zone. To prevent drowning of any emitted fluorescence or change in optical properties, the point light sources 38a and 38b are of low intensity, such as having a brightness just enough to consistently register in images, and are spaced from a microplate that is received in use in the incubation station 16 to prevent light bleeding from the point light source 38a and 38b to the microplate.

The source of electromagnetic radiation that is used to illuminate the samples in each incubation station 16 can have a first wavelength range. The detector 18 (e.g. cameras 21a-21d) are generally configured to detect electromagnetic radiation emitted by the plurality of samples in a second wavelength range. The first wavelength range is typically different to the second wavelength range. For example, the source of electromagnetic radiation may be a UV light which emits light having a wavelength of 100 nm-400 nm, and the camera 20 can be fitted with a UV filter to block out UV light and only detect visible light having a wavelength >400 nm. In an embodiment, light from the light-based datum system 40 is visible in the second wavelength range.

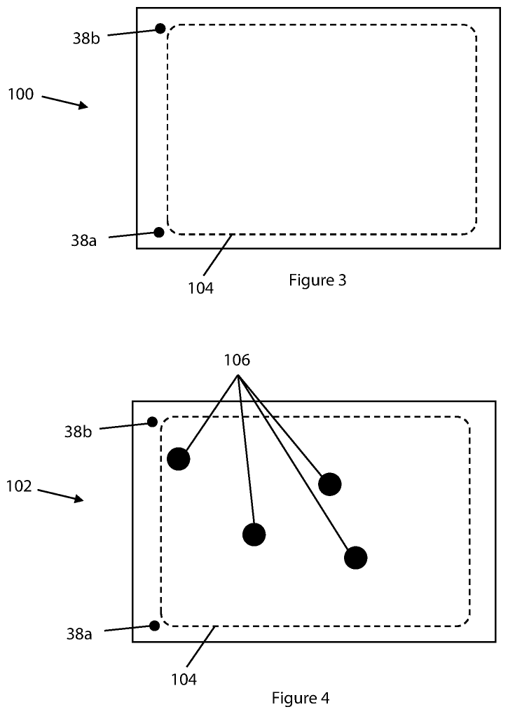

During the initial stages of incubation where there is not yet a fluorometric response in any of the samples, a resulting image of an incubation station 16 would be devoid of any signal on account of filters and the like that would block any light from the source of electromagnetic radiation used to excite fluorometric agents in the samples from reaching the detector 18. However, and as shown in FIG. 3, the point light sources 38a and 38b provide a light signal that is detected and captured by the camera (i.e. detector 18) to provide an image 100 having a frame of reference to allow correct orientation and alignment of subsequent images. The location of the incubation station 16 in image 100 is shown as a dashed line 104 to aid in explanation and in practice would not be visible in image 100.

During incubation, some of the samples in the incubation station 16 will provide a fluorometric response, as indicated in FIG. 4 by dots 106, which will be captured in image 102. Therefore, the electromagnetic radiation emitted by the plurality of samples and the light from the point light sources 38a and 38b are detected simultaneously. Having the light sources 38a and 38b be present in images 100 and 102 allows the orientation of the images 100 and 102 to be correctly orientated. The electromagnetic radiation emitted by the plurality of samples and the light from the point light sources 38a and 38b may be detected using for example a multisensor dichroic prism or a pixelated multispectral filter array cameras, or via CCD or CMOS cameras or detectors linked to beam splitters.

In an embodiment, the system 10 is configured such that the electromagnetic radiation emitted by the plurality of samples can be detected simultaneously. In an embodiment, the system 10 is configured such that the electromagnetic radiation emitted by the plurality of samples can be detected at least quasi-simultaneously using synchronised detection of the light emitted from the light-based datum location system. The term “quasi-simultaneously” as used herein means two processes occurring in sequence but at such a rate that the two processes are considered to occur essentially simultaneously.

In an embodiment, the electromagnetic radiation emitted by the plurality of samples can be detected at least quasi-simultaneously using synchronised detection of the light emitted from the light-based datum system, such as from point light sources 38a and 38b. When the detector 20 and incubation zone 14 are moveable relative one another, the system 10 may be configured such that the at least quasi-simultaneous detection of the electromagnetic radiation emitted by the plurality of samples includes detecting light from the light-based datum system (e.g. point light sources 38a and 38b) either at a predefined interval immediately before or immediately afterward detection of the electromagnetic radiation emitted by the plurality of samples followed by time resolution to allow calculation of location of the plurality of samples from the light-based datum system by interpolation of the trajectory of relative motion of the detector and the incubation zone.

An advantage of using light-based datum system 40 to provide a reference to orientate images of the samples in each incubation station 16 is that it eliminates the need for mechanical location measurement. For example, encoders and stepper motors can be used to monitor a location of an object relative another object, but to achieve a measurement accuracy required to orientate subsequent images requires fine tolerances and expensive electrical equipment. Such a mechanical location measurement setup would also limit the speed at which the detector 18 can be moved across the incubation zone 14, thereby reducing sample throughput and/or accuracy of results. In contrast, the light-based datum system 40 can achieve image alignment at a pixel-level resolution using high detector movement speeds. Mechanical location measurement also must be performed for pre-imaging/detection alignment whereas the light-based datum system 40 allows for post-image/detection alignment which means image/detection capture is not a rate-limiting step during the analysis of samples in screening system 10.

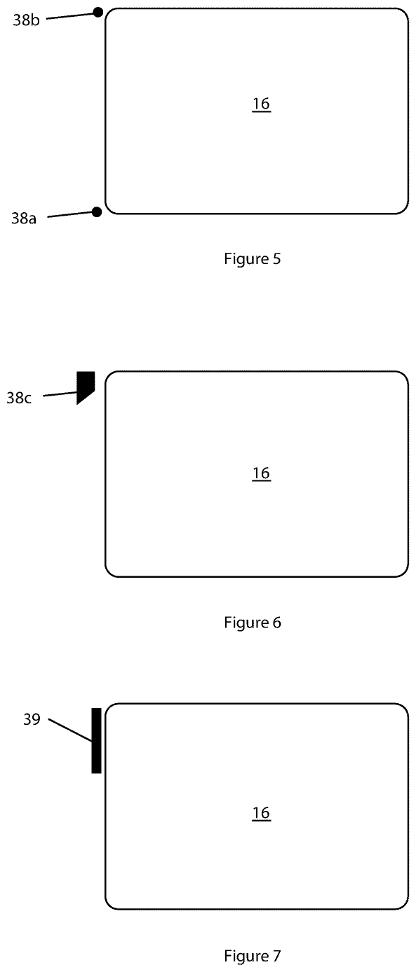

The light-based datum system 40 has been described with using point light sources 38a and 38b (as shown in FIG. 5), but the light-based datum system 40 can be embodied in other forms. For example, and as shown in FIG. 6, the light-based datum system 40 could use a single light source 38c that has an asymmetrical outline. In another embodiment, and as best shown in FIG. 7, the light-based datum system 40 includes a photodetector 39 and a laser source fitted onto the gantry 22 and directed down to the incubation zone 14. As the gantry 22 moves across the incubation zone 14 during incubation to detect and monitor incubation at the incubation stations 16, laser light from the laser source on the gantry 22 sweeps over the photodetector 39. When the photodetector 39 detects the laser light, this event is used as a trigger by the screening system 10 to detect/image the samples in an incubation station 16. In this way, use of a laser light and photodetector 39 ensures detection/imaging is performed at the same location relative the photodetector 39 thereby ensuring any resulting images are correctly orientated.

In another embodiment, the light-based datum system 40 can include an ultrasonic detector or laser to reflect off an end of the incubation zone 14 or another fixed location on the structure 12 to provide a distance reference along a length of the incubation zone 14. Predefined locations as measured by the ultrasonic detector or reflected laser light can be used as a trigger by the screening system 10 to detect/image the samples in an incubation station 16.

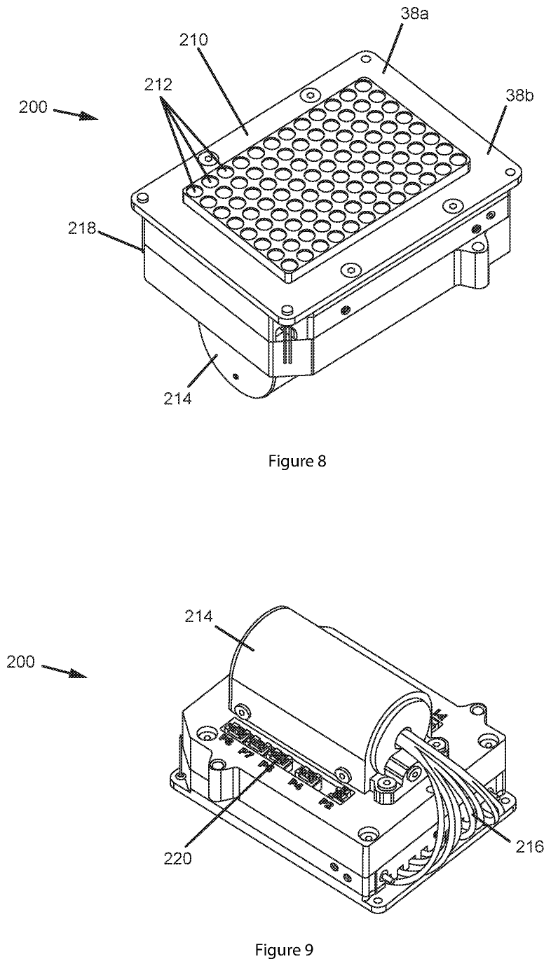

In an embodiment, the incubation stations 16 are fixed in the incubation zone. However, in another embodiment and as best shown in FIG. 8 and FIG. 9, the incubation stations 16 are each in the form of an incubator unit 200 that is individually removable from the incubation zone 14. When the incubation stations 16 are each in the form of an incubator unit 200, the incubation zone 14 includes one or more wells into which one or more incubator units 200 can be received. Accordingly, the terms incubation stations and incubation wells can be used interchangeably.

The incubator unit 200 has a thermal regulator or heating element in the form of receptacle plate 210. The receptacle plate 210 is positioned or located in an in-use upper portion of the incubation unit 200 and has a plurality of receptacles 212 that can each receive a sample. In the embodiment shown in FIG. 8, the receptacle plate 210 has 96 receptacles 212 that can receive a 96-well plate insert. A thermostatically controlled heating element is in thermal communication with the receptacle plate 210 for heating or cooling the receptacle plate 210. Typically, the incubator unit 200 will heat samples received in the receptacles 212. However, in some cases the incubator unit 200 will need to cool samples received in the receptacles 212. For example, if the incubator unit 200 is used in a hot climate and incubation conditions require an incubation temperature below an ambient temperature, such as for incubation conditions near 20° C., the incubator unit 200 is configured to cool the samples received in the plurality of receptacles 212. In an embodiment, the incubator unit 200 includes a piezoelectric or a thermoelectric (Peltier) unit to heat or cool the receptacle plate 210. Accordingly, the term “heating element” as used throughout this disclosure is not limited to heating and can also provide cooling. In this way, the term “heating element” can be used interchangeably with the term “thermal regulator”.

The incubation unit 200 also has a source of electromagnetic radiation in the form of light source 214 that is positioned or located in an in-use lower portion of the incubation unit 200. Each receptacle 212 is optically connect the light source 214. In the embodiment shown in FIG. 1 and FIG. 9, each receptacle 212 is optically connect the light source 214 via fibre optic cables 216. However, the use of fibre optic cables is only one example and other optical coupling means could be used, for example by direct illumination.

With each incubation unit 200 having its own heating element and light source, the incubation conditions for each incubation unit 200 can be specific and independent of one another. Referring to screening system 10 as an example only, each of the 12 incubation stations 16 (i.e. wells) can receive an incubation unit 200, and each of the incubation units 200 can have their own incubation conditions. Optionally, some of the incubation units 200 can be grouped together depending on incubation conditions. For example, a first set of incubation units 200 can have a first incubation condition, and a second set of incubation units 200 can have a second incubation condition. Incubation may be isothermal. Each incubator unit 200 can be operated independent of one another.

In an embodiment, the incubation unit 200 is replaceable such that each incubation unit 200 can be installed or removed independent of one another. The incubation unit 200 may be pre-programmed to perform a specific type of incubation. For example, a first incubation unit 200 may be programmed with a first incubation condition to identify a first pathogen(s) or genetic difference(s), and a second incubation unit 200 may be programmed with a second incubation condition to identify a second pathogen(s) or genetic difference(s). If a screening system e.g. 10 was fitted with the first incubation unit and the second incubation unit, the screening system could simultaneously identify two or more sets of pathogens or genetic differences based on different incubation conditions. The incubation condition includes heating characteristics such as isothermal vs non-isothermal heating and illumination characteristics such as driving a single light source or alternating multiple light sources.

An advantage of having the incubation unit 200 be pre-programmed is that it makes it easier for a user to change the type(s) of pathogens or genetic differences that are to be identified by the screening system, and the type(s) of required incubation. For example, if the screening system 10 is fitted with a first type of incubation unit 200 that has a first incubation condition, a user could simply swap out one or more of the first type of incubation units 200 with a second type of incubation unit 200 that has a second incubation condition.

In an embodiment, the incubator unit 200 includes an identifier that can be read by the incubation station 16 or screening system 10, for example by a central processing unit, upon installation of the incubator unit into the incubation station 16. For example, each incubation unit 200 may be provided with a unique code or similar that allows the incubation station 16 or screening system 10 to identify the type of incubation unit 200 and the associated predefined incubation conditions. The identifier can be communicated to the incubation station 16 or screening system 10 by a communication means such as RFID, CAN Bus, Ethernet connection, optical scanning, barcode or QR code, and so on. Using a wired connection to communicate the identifier may also provide power to the incubation unit 200. However, power could be delivered using a specific interface, such as sockets and plugs, independent from the means of communicating the identifier.

Using an identifier to tell the incubation station 16 or screening system 10 what type of incubation unit 200 is placed in the incubation station 16 helps to remove user input and any associated user error when installing the incubation unit 200. This may be beneficial when a user needs to carry out maintenance or needs to update the incubation zone 14, for example by swapping the incubation units 200 from one type to another. Embodiments where the incubation stations 16 are each in the form of an incubator unit 200 that is individually removable from the incubation zone 14 can help the screening system 10 to offer greater flexibility in the types of pathogens or genetic differences and their associated methods of identification that can be identify by the screening system 10.

In an embodiment, the incubation unit 200 includes a light-based datum system. As shown in FIG. 8, the incubation unit 200 can include point light sources 28a and 38b. Including the light-based datum system into the incubation unit 200 means the datum points always remain in a fixed position relative the receptacles 212, helping to improve accuracy when aligning images of the samples received in the receptacles 212.

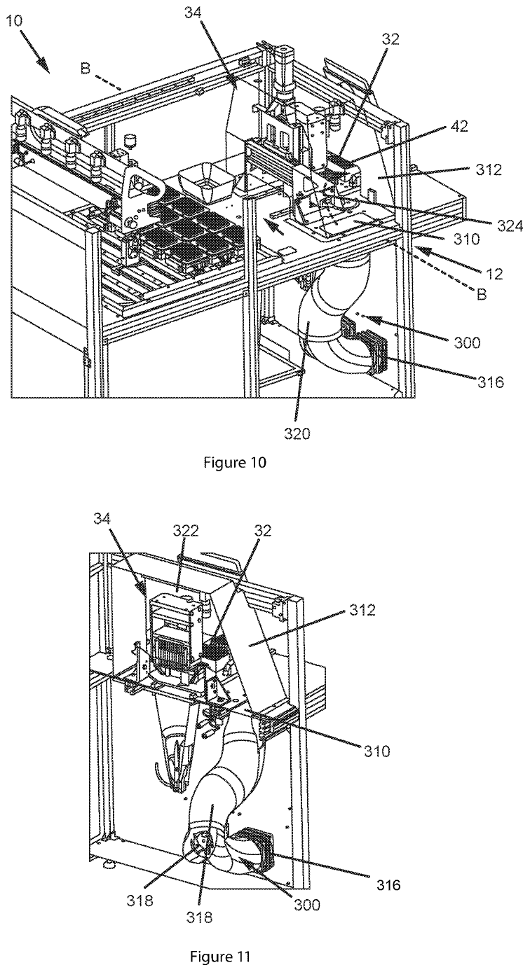

An embodiment of the screening system 10 includes an airflow system 300, as best seen in FIG. 10, FIG. 11, and FIG. 12. Note that for ease of reference, not all features of the screening system 10 are identified with numerical references in FIG. 10, FIG. 11, and FIG. 12. The airflow system 300 has an inlet 314 positioned on an outside of the structure 12 such that the inlet 314 can such in suck air in from an environment outside of the screening system 10. A filter, such as a HEPA filter, is provided in the inlet 314. The filter is accessible by a user from an outside of the inlet 314. The inlet 314 is also provided with a motor unit 316 that has a fan 318 that can suck in air through the filter. The filter removes particulate matter from air that is sucked through the inlet 314 thereby forming purified air. The purified air is then blown through pipe 320 where it exits through outlet 310.

A housing 312 is provided over the pipetting system 34 to form a pipetting chamber 322. The pipetting chamber 322 can be considered as a liquid handling chamber. The outlet 310 is positioned within the pipetting chamber 322 such that purified air can exit the outlet 310 into the pipetting chamber 322. In an embodiment, the airflow system 300 is configured to maintain a pressure inside the pipetting chamber 322 at an elevated pressure compared to an environment outside of the pipetting chamber 322. The window 30 allows air under relative pressure to exit the pipetting chamber 322. Such an elevated pressure means purified air exits the pipetting chamber 322 via window 30, as illustrated by the travel path of dashed line 324. The purified air may continually exit through window 30. Having purified air continually exit the pipetting chamber 322 helps to reduce the likelihood of foreign or particulate or aerosoled matter from passing through the window 30 into the pipetting chamber 322 and contaminating the samples that are to be analysed by screening system 10. Purified air may also exit the pipetting chamber 322 on a pick-up zone 31 side of the pipetting system 34 and be directed to the incubation zone 14.

In an embodiment, and as best seen in FIG. 13 the airflow system 300 is provided with a duct 326 that is defined between a sidewall 328 and a wall of the housing 312. The duct 326 has opening 310a that is positioned towards a top or upper portion of the pipetting chamber 322. The duct 326 directs purified air up to a top portion of the pipetting chamber 322 through opening 310a such that purified air flows down over and/or through components of the pipetting system 34 and either outwards through the window 30 or towards the incubation zone 14. This flow of purified air is represented as arrows 330 in FIG. 13. The duct 326 may help to reduce circulation of purified air within the pipetting chamber 322.

Now referring back to FIG. 1, in an embodiment the screening system 10 includes a detector for detecting one or more physical conditions of the screening system 10 in the form of ultrasonic detector 48. The ultrasonic detector 48 is mounted to the robotic system 28 and can detect one or more physical conditions of the screening system 10 in an area below the robotic system 28 at one or more predefined locations. In an embodiment, the ultrasonic detector 48 can detect a height-based condition of the components of the screening system 10 at one or more predefined locations, such as in a Z direction. For example, certain actions result in the presence or absence of a component. Taking the placement of a new set of samples in an incubation station 16 as an example, there is a difference in height in the z direction between the absence and presence of a sample in the incubation station 16.

If the ultrasonic detector detects a height of a component is outside a predefined condition, a trigger may be tripped to alert a user of an error in the screening system 10. For example, if the screening system 10 calculates that a sample should be at a specific incubation station 16, which would be associated with a physical condition of the incubation station 16 of a known height, but the ultrasonic detector 48 detects that a detected height is outside the physical condition of a sample in the incubation station 16, a trigger would be tipped. Accordingly, the ultrasonic detector 48 can be used to detect the presence of absence of an object in one or more locations in the screening system 10. A physical condition can also include whether a gripper 52 of the robotic system 28 has correctly picked up a microplate. A physical condition can also include the presence or absence of a microplate in the pick-up zone 31 and/or incubation station 16. In an embodiment, the robotic system 28 is configured to remove the individual samples or groups of samples from the incubator station 16 leaving vacant sample holders or groups of sample holders. The robotic system 28 may be that as outlined in PCT/AU2021/051209 or PCT/AU2022/051036.

The ultrasonic detector 48 can also be used to detect a fill level of the bin 50. In use, waste samples such as waster microplates are disposed of in the bin as described above. As more samples are placed in the bin 50, a fill level of the bin 50 increases. This increase in fill level is associated with a change in height in the Z direction. Accordingly, the ultrasonic detector 48 can be used to detect when a level of waste in the bill is reaching a maximum level. The fill level of the bin 50 may be staggered. For example, a user signal may be triggered when the bin reaches a first fill threshold, such as 80% full. A second or more fill threshold, such as 90% full, may then be triggered. A final maximum fill level, such as 100% full, may trigger such that the screening system 10 stop loading new samples until a user empties the bin 50. Accordingly, the ultrasonic detector 48 may be used to prevent fouling and/or damage of the screening system 10, and may help improve accuracy or at least detect sources of error during incubation and analysis.

The embodiments described above relate to the screening system 10 that has a plurality of incubation stations 16. However, principles of the disclosure also relate to a screening system that has one or two incubation stations. For example, in such embodiments, the detector may be fixed and movement of the detector (e, g, 18) relative the incubation station(s) may be achieved by manually moving the incubation station relative to the detector. Other principles of the disclosure such as embodiments relating to the use of a light-based datum system, a removeable incubation unit, the use of an airflow system, and so on, also apply to a screening system that has one or two incubation stations.

Although the detailed description makes reference to 96-well plates, the disclosure is not limited to 96-well plates and can include any type of microplate such as 6-, 24-, 48-, 96-, 384- and 1536-well plates, and so on.

In the claims that follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

Modifications and variations as would be apparent to a skilled addressee are deemed to be within the scope of the present disclosure.

1-40. (canceled)

41. A screening system configured to identify biological agents, biological differences, pathogens and/or genetic differences, comprising:
an incubation zone having an incubation station for incubating a plurality of samples;
an incubator unit that is receivable in the incubation station, the incubator unit being replaceable and comprising:
a thermal regulator having a plurality of receptacles that can each receive a sample, the thermal regulator being configured to heat or cool the plurality of receptacles; and
a source of electromagnetic radiation for illuminating one or more of the receptacles; and
a detector for detecting electromagnetic radiation emitted by the plurality of samples.

42. The screening system as claimed in claim 41, comprising a plurality of incubation stations that each receive an incubator unit.

43. The screening system as claimed in claim 42, wherein each incubator unit is operable independent of one another.

44. The screening system as claimed in claim 41, wherein the thermal regulator is positioned in or forms an in-use upper portion of the incubator unit and the source of electromagnetic radiation is positioned in or forms an in-use lower portion of the incubator unit.

45. The screening system as claimed in claim 41, wherein each receptacle is optically connected to the source of electromagnetic radiation via a fibre optic cable.

46. The screening system as claimed in claim 41, wherein the incubator unit includes an identifier that is read by the incubation station upon installation of the incubator unit into the incubation station, wherein the identifier is used to identify predefined operational conditions of the incubator unit.

47. The screening system as claimed in claim 41, wherein the incubator unit includes a light-based datum system that generates light that is used as a reference point to orientate images of the incubation station captured by the detector.

48. The screening system as claimed in claim 47, wherein the source of electromagnetic radiation is configured to illuminate the plurality of samples in a first wavelength range and the detector is configured to detect electromagnetic radiation emitted by the plurality of samples in a second wavelength range, and wherein the second wavelength range is different to the first wavelength range and the light-based datum system is visible in the second wavelength range.

49. The screening system as claimed in claim 47, wherein the detector is configured to detect light emitted from the light-based datum system.

50. The screening system as claimed in claim 41, wherein the electromagnetic radiation emitted by the plurality of samples is detected simultaneously.

51. The screening system as claimed in claim 41, wherein the detector and incubation station are moveable relative one another.

52. The screening system as claimed in claim 51, further comprising a gantry mechanism configured to move the detector across the incubation zone.

53. The screening system as claimed in claim 51, wherein the electromagnetic radiation emitted by the plurality of samples can be detected at least quasi-simultaneously using synchronised detection of the light emitted from the light-based datum location system and that the at least quasi-simultaneous detection of the electromagnetic radiation emitted by the plurality of samples includes detecting light from the light-based datum system either at a predefined interval immediately before or immediately afterward detection of the electromagnetic radiation emitted by the plurality of samples, followed by time resolution to allow calculation of location of the plurality of samples relative to the light-based datum system by interpolation of the trajectory of relative motion of the detector and the incubation zone.

54. The screening system as claimed in claim 41, wherein the detector is a fixed detector and has a field of view that captures at least one incubation station.

55. The screening system as claimed in claim 41, comprising a plurality of detectors.

56. The screening system as claimed in claim 41, wherein the detector is a fixed detector and has a field of view that captures at least one incubation station, and the system further comprises a plurality of detectors and a plurality of incubation stations, wherein each detector of the plurality of fixed detectors is configured to record radiation emitted from some of the plurality of incubation station such that the plurality of fixed detectors in combination records radiation emitted the plurality of incubation stations,

57. The screening system as claimed in claim 55, wherein each detector of the plurality of detectors is configured to record radiation emitted by the plurality of samples at a predefined wavelength or one or more predefined wavelengths that is different to the other of the detectors of the plurality of detectors.

58. The screening system as claimed in claim 55, wherein at least one of the plurality of detectors is configured to record radiation emitted by the plurality of samples at a predefined wavelength that is distinguished from at least one of the detectors of the plurality of detectors, such at least one detector of the plurality of detectors is configured to record radiation at a similar time to the other but distinguished by a time resolved detection of asynchronous radiation in response to an excitation pulse.

59. The screening system as claimed in claim 41, further comprising a liquid handling system for transferring liquid reagents to the plurality of samples, wherein the liquid handling system includes a pipette for transferring liquid and that in use receives and dispenses pipette tips from a pipette tip rack.

60. The screening system as claimed in claim 59, further comprising an airflow system having an inlet positioned to suck air in from an environment outside of the screening system, a filter, and an outlet located in a chamber that houses the liquid handling system, the airflow system being configured to:
suck air in through the inlet and filter to form purified air and then blow the purified air into the chamber that houses the liquid handling system; and
maintain the chamber that houses the liquid handling system at an elevated pressure compared to an environment outside of the chamber that houses the liquid handling system.
